(19) United States
(12) Patent Application Publication
(10) Pub. No.: US 2007/0067407 A1
(43) Pub. Date: Mar. 22, 2007

(54) DELIVERY OF VIDEO MAIL AND VIDEO MAIL RECEIPT NOTIFICATIONS

(76) Inventors: Sonny R. Bettis, Lawrenceville, GA (US); Ian M. Moraes, Suwanee, GA (US); Jon S. Plotky, Lawrenceville, GA (US); Philip L. Lowman, Ellijay, GA (US); James H. Spencer, Tucker, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/307,578

(22) Filed: Feb. 13, 2006

Related U.S. Application Data
(63) Continuation-in-part of application No. 11/170,530, filed on Jun. 29, 2005.
Application No. 11/170,530 is a continuation-in-part of application No. 11/080,744, filed on Mar. 15, 2005.
(60) Provisional application No. 60/584,117, filed on Jun. 30, 2004.

(51) Int. Cl. G06F 15/16

(52) U.S. Cl. 709/207

(57) ABSTRACT

Video content is delivered in a bandwidth efficient manner to a destination device. The video content is analyzed and a compression operation is performed on the video content prior to delivery to the destination device. Any audio associated with the video content is maintained in synchronization with the video content. The compression of the video can be performed in a variety of manners including single transmission of static frames, combining substantially similar frames so that only a single frame representing the combination is transmitted, and only transmitting dynamically changing or active portions of the video content.

### CROSS-REFERENCE TO RELATED APPLICATIONS

This application is a continuation-in-part of United States patent application filed on Mar. 15, 2005 and assigned Ser. No. 11/080,744, United States patent application filed on Jun. 29, 2005 and assigned Ser. No. 11/170,459, and United States patent application filed on Jun. 29, 2005 and assigned Ser. No. 11/170,530, each of which claim the benefit of the filing date of United States Provisional Application for patent entitled DISTRIBUTED IP ARCHITECTURE FOR TELECOMMUNICATIONS SYSTEM, filed on Jun. 30, 2004 and assigned Ser. No. 60/584,117.

This application is related to a United States patent application Ser. No. ______ that has a title of DISTRIBUTED IP ARCHITECTURE FOR TELECOMMUNICATIONS SYSTEM WITH VIDEO MAIL, was filed concurrently with this application and is hereby incorporated by reference in its entirety.

### BACKGROUND OF THE INVENTION

The present invention relates to the techniques for the delivery of video mail or video messages to intended recipients and the delivery of notifications pertaining to the receipt of video mail and video messages.

It wasn't that long ago that if you were not physically present to answer a telephone call, you simply did not receive the call and the calling party had to try again later. In the fast paced, always connected world that we live in today, such treatment is certainly not accepted. Today, many people have voice mail services for home, for the office and for a mobile telephone, as well as multiple email accounts for personal or business related email correspondence. So rather than simply missing a call, today many individuals spend a significant amount of time checking the various message depositories to determine if anyone has tried to contact them and/or left a message.

One of the recent advancements in messaging capabilities for telecommunication technology is the provision of video mail. As described in the above-identified related patent application, systems for receiving, storing and providing playback of video messages can provide support for video messaging and video mail technology. However, with the introduction of such technology, users are faced with yet another message depository that much be periodically checked to determine if a message is waiting. Furthermore, the burden associated with this task can be even more exaggerated by the fact that special user devices may be required to access and playback video messages. For instance, the video mail server may interface to video capable devices over a digital wireless network such as the third generation wireless networks.

What is needed in the art is a technique for providing the delivery of video messages to subscribers in a convenient manner. Convenience in this circumstance can be measured by the amount of effort that must be expended by the subscriber in determining a message has been received and then taking the steps necessary to retrieve and review the message. Coupled with this is the provision of flexibility in the types of equipment and the mannerisms in which the subscriber can obtain the video messages.

Aspects and features of the present invention are directed towards meeting these needs in the art.

### BRIEF SUMMARY OF THE INVENTION

The present invention addresses the above-described needs in the art by providing techniques for the delivery of video messages, such as video mail, by delivering the video messages to a variety of platforms in a variety of formats or providing message receipt notifications to enable subscribers to easily access such video messages.

In one embodiment, the present invention converts video messages to a widely used video format and then forwards the converted file to a subscriber's email account. Advantageously, this aspect of the present invention enables a subscriber to access a video message using a personal computer or any video capable device that has access to that email account.

In another embodiment, the present invention creates a message receipt notification and sends that notice to the subscriber. The notice can be delivered in a variety of manners including email, SMS, text messaging, blogs, RSS feeds, instant messaging technology or the like. The notification can include a simple notice to instruct a user to access the video message system, or can be more elaborate such as including a URL or a hyperlink to facilitate accessing the video message.

In another embodiment of the present invention, a video clip of the video message, or simply a thumbnail or still image of a portion of the video message can be emailed to the subscriber, either to his or her email account or a video email account is one exists. In such an embodiment, the message may be accompanied by the audio portion of the video message. Alternatively, only the audio portion of the message may be delivered to the subscriber. In another embodiment, the video clip can be emailed to the subscriber's voice mail account from which it can be delivered as video mail.

In yet another embodiment of the present invention, the video message system can take the appropriate actions or send the necessary signals to a user device to activate a message notification signal. Such a signal may include lighting an LED on the user device, turning on an icon on the display of the user device, sound a buzzer or ring-tone, or the like to indicate that a video message has been received.

These embodiments and aspects of the present invention, as well as other aspects, features and elements of the present invention will be further described in conjunction with the figures and the detailed description.

### BRIEF DESCRIPTION OF THE SEVERAL VIEWS OF THE DRAWING

Various aspects, features and advantages of the present invention will become fully appreciated as the same becomes better understood when considered in conjunction with the accompanying drawings, in which like reference characters designate the same or similar parts throughout the several views, and wherein:

FIG. 1 is a block diagram illustrating an exemplary environment in which various embodiments of the present invention can be implemented.

FIG. 2 is a flow diagram illustrating the operation of one embodiment of the present invention.

FIG. 3 is a flow diagram illustrating an embodiment of the present invention that provides email notifications to a subscriber in a form that includes an embedded copy of the video message.

FIG. 4 is a flow diagram illustrating another embodiment of the present invention in which a hyperlink is included in a video message reception notification email message.

### DETAILED DESCRIPTION OF THE INVENTION

The present invention is directed towards enhancing the deliver of video messages to a subscriber by either providing alternate mechanisms for the delivery of the video message or by facilitating access to the video message for a subscriber.

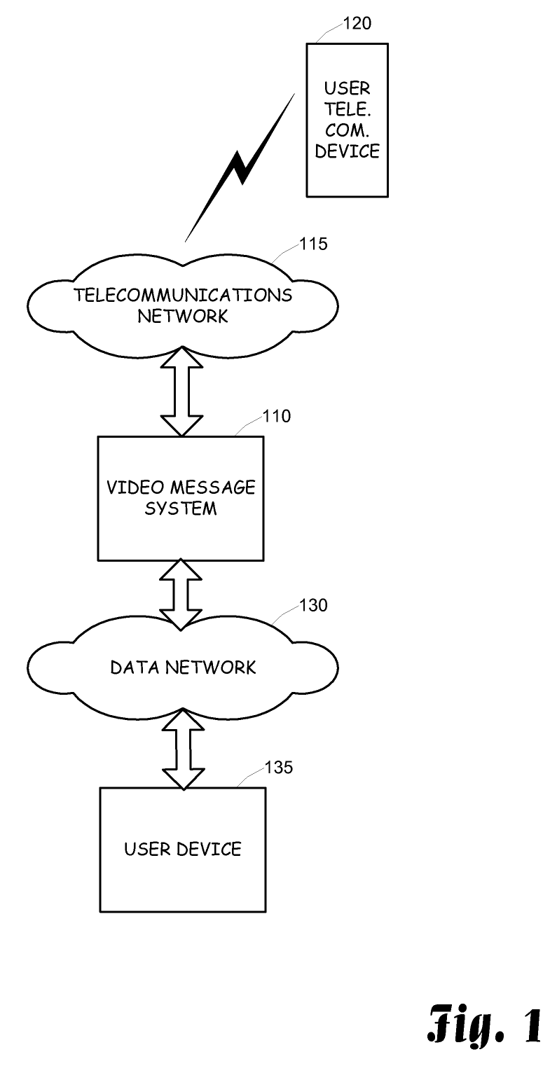

FIG. 1 is a block diagram illustrating an exemplary environment in which various embodiments of the present invention can be implemented. The illustrated environment includes a video messaging system 110 that is communicatively coupled to a telecommunications network 115 and a data network 130. The video messaging system 110 communicates with one or more user telecommunication devices 120 through the telecommunications network 115. In addition, the video messaging system communicates with one or more user devices 135 through the data network 130.

The video messaging system 110 can exist in a variety of configurations. One such configuration is the video messaging telecommunications platform described in the above-referenced related patent application. In this embodiment, the video messaging system is a distributed telecommunications platform that supports voice mail and video mail services, along with other voice and video services for a group of subscribers. However, it should be understood that the video messaging system 110 can take on a variety of other configurations, all of which would be suitable for embodiments of various aspects of the present invention. For instance, the video messaging system could be a news bulletin service that provides video messages to subscribers on a periodic basis, similar to an RSS type of relationship. The video messaging system could be an advertising system pushing content to various subscribers. Likewise, the video messaging system 110 may be an information service, educational service, reminder service, weather or traffic related services, or any of a variety of other types of services or platforms. In general, the video messaging system 110 simply is an embodiment of a system that periodically receives or creates video messaging content that is directed towards a subscriber.

In a more particular embodiment, the video messaging system 110 interfaces to a telecommunications network, such as a third generation wireless network, that supports the provision of video messaging services. In such an embodiment, the video system 110 may receive a video message from the telecommunications network 115 that was initiated by a wireless device 120. For instance, a user of device 120 may call a subscriber of the video messaging system 110 and leave a video mail message for that subscriber. Similarly, a subscriber utilizing wireless device 120 may call into the video messaging system 110 over the telecommunications network 115 to retrieve any video messages that have been receive for the subscriber.

The video message system 110 also interfaces to other types of equipment 135 over a data network 130. A common embodiment of this structure may include a personal computer that is coupled to the Internet. However, the present invention is not limited to such an embodiment. In fact, the video message system may interface to other equipment through the data network 130, including but not limited to, other wireless communication devices that connect to the data network through another intermediary system, voice mail systems, paging systems, text messaging systems, etc.

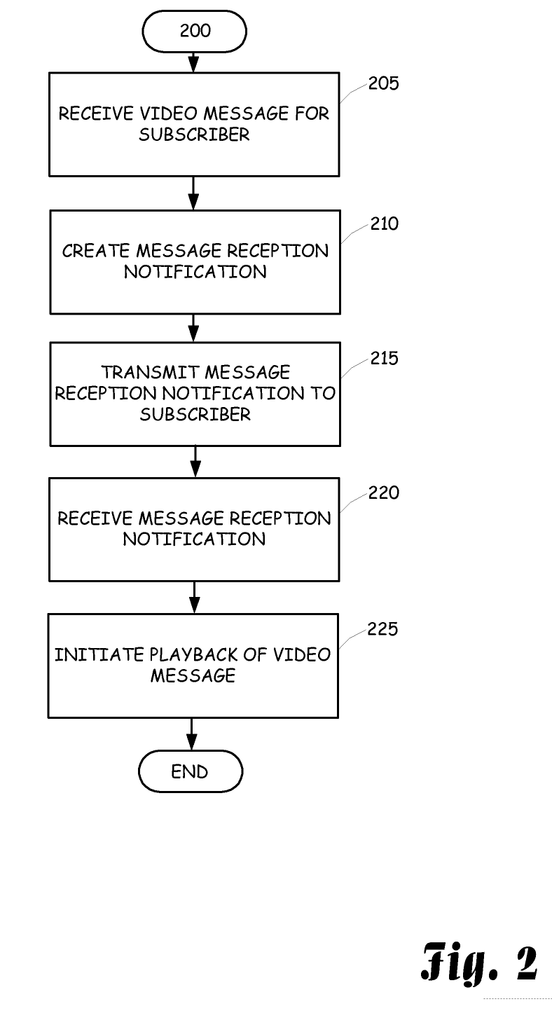

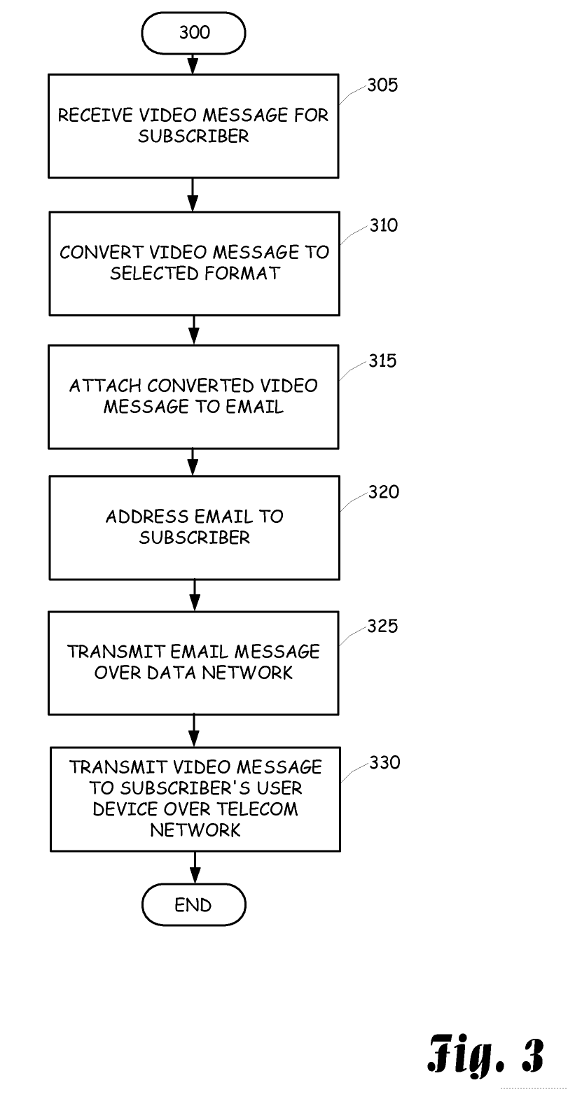

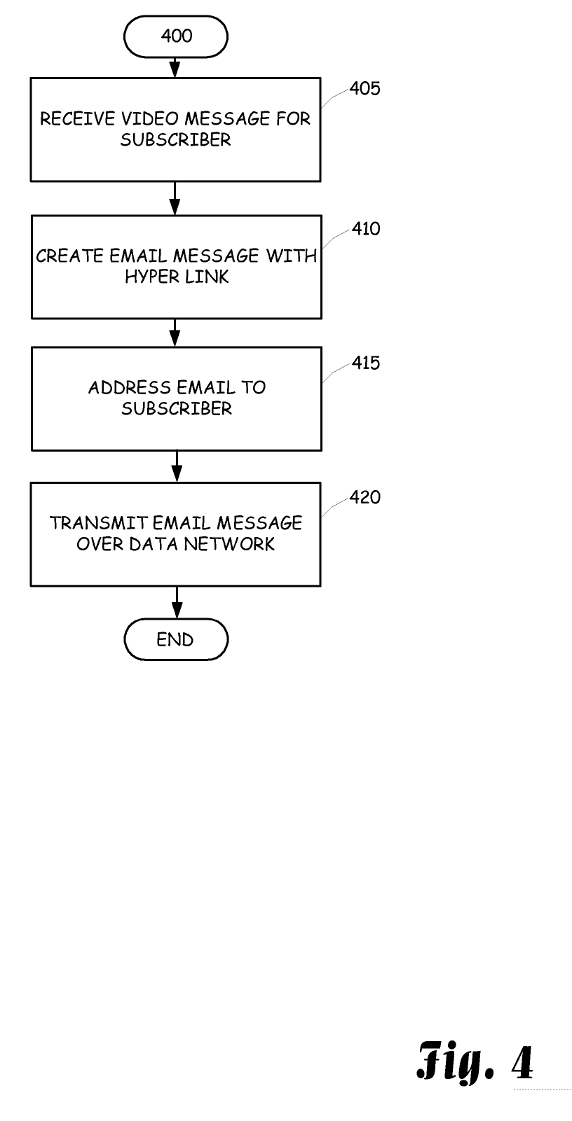

FIG. 2 is a flow diagram illustrating the operation of one embodiment of the present invention. The operations depicted in FIG. 2 could easily be implemented in an environment similar to that disclosed in FIG. 1 or other functionally similar embodiments. The process 200, in general receives video messages for a subscriber, provides a notification of such reception to the subscriber, and allows the subscriber to retrieve the video message. The process 200 begins by receiving a video message for the subscriber. Again, this video message can be received from an external device that is directing the video message to the subscriber or, can be generated internally by the video system in accordance with a predefined schedule, user profile, or the like. In response to receiving the video message, a message reception notification is generated 210. As will be described in more detail in conjunction with FIGS. 3 and 4, the message reception notification can take on a variety of formats ranging from a simple tickler to notify a subscriber that a message has been received, to actually providing a formatted version of the video message.

Once generated, the message reception notification is transmitted to the subscriber. In the environment illustrated in FIG. 1, this would include transmitting a message over the data network 130 to the user device 135. However, it will also be appreciated that this message notification may also be transmitted to the user telecommunications device 120 over the telecommunications network 115. Having both of these capabilities advantageously helps to more readily notify the subscriber of the message reception. When the telecommunications device 120 is a digital wireless cellular telephone, the provision of the message reception notification will afford the subscriber the opportunity to retrieve the video message using the digital wireless cellular telephone or, attempting to retrieve the video message utilizing a different, possible more video centric device. Thus, the subscriber can receive notification of the message reception but then move to a device that has greater bandwidth for downloading the video message.

The message reception notification is received by the user device 220 and then the subscriber can initiate the playback of the video message 225.

FIG. 3 is a flow diagram illustrating an embodiment of the present invention that provides email notifications to a subscriber in a form that includes an embedded copy of the video message. The process 300 begins upon the reception of a video message for a subscriber 305. Among other actions, the video message can be converted into a selected format 310. The selected format can be any of a variety of different formats including, but not limited to DVD/VCD, AVI, MPEG, WMV, RM, RMVB, DivX, ASF, and VOB. In essence, the video messaging system can maintain a subscriber profile that identifies a desired or preferred format that is most suitable to the subscriber's equipment, software utilities or wishes. Alternatively, one of the more popular formats can be selected as a default, such as AVI or MPEG.

Once the video message is converted into the selected format, the converted message is attached to an email message 315. The email message is then addressed to an email address that is identified as the desired email address for the subscriber 320. Depending on the implementation, this email address may be selected based on profile information regarding the subscriber, can be changed based on external circumstances such as scheduling, time, days, etc. and can even be sent to multiple email addresses. The email message is then sent to the subscriber's email box so that it can be retrieved using the subscriber device 325. In addition, in some embodiments of the invention, the video message can be transmitted, or a notification of the reception of the video message can be transmitted to the subscriber's telecommunication device over the telecommunications network 330.

FIG. 4 is a flow diagram illustrating another embodiment of the present invention in which a hyperlink is included in a video message reception notification email message. In this embodiment, the process 400 begins when a video message for a subscriber is received or generated by the video message system 405. In response, an email message is created and a hyperlink to the video message is included in the email message 410. The email message is then addressed to the subscriber as described above 415 and then transmitted to the subscriber over the data network 420.

It will be appreciated that email messages are only one mechanism that can be employed as a vehicle for the present invention. Many systems, especially cellular systems, implement short messaging service (SMS) technology. The present invention can also exploit the SMS technology to send a notification to the subscriber that a video message has been received. Such a message can include the video message, a reformatted version of the video message, a hyperlink to the video message, a URL at which to access the video message, etc.

The present invention can also utilize other vehicles for the delivery of such message notifications. In addition to email and SMS technology, the present invention can exploit technology such as blogs, RSS feeds, text messaging, instant messaging technology or the like. In each of these embodiments, the notification can include a simple notice to instruct a user to access the video message system, or can be more elaborate such as including a URL or a hyperlink to facilitate accessing the video message.

In another embodiment, the present invention may be utilized to provide other notification messages. For instance, if a user device is so equipped, the video message system can transmit a message to the user device to display an icon, light an LED, sound an audible tone, vibrate a buzzer, etc. In another embodiment, a clip from the video message or simply a thumbnail still shot can be extracted and transmitted to the user device. In another embodiment, only the audio portion of a video message may be sent to the user device. In addition, if the subscriber has a video mail box, the video message may simply be transmitted or emailed to the subscriber's video mail box.

Thus, it has been shown that the present invention provides a system and method for providing the delivery of video messages and notifying subscribers of the reception of video messages. Although the primary application for the invention has been described as providing video messages and notifications for subscribers of a digital wireless network that supports video services, those skilled in the art will appreciate that the various aspects and features of the present invention can be equally applied in a variety of environments. Thus, the present invention has been described using detailed descriptions of embodiments thereof that are provided by way of example and are not intended to limit the scope of the invention. The described embodiments comprise different aspects and features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

What is claimed is:

1. A method for enhancing the delivery of video messages received at a video message telecommunications platform for a particular subscriber, the video message telecommunications platform supporting the delivery of video messages to digital wireless devices over a digital wireless network, the method comprising the steps of:
receiving a video message directed to the particular subscriber;
generating a message reception notification;
transmitting the message reception notification to the subscriber;
receiving message reception notification; and
initiating the playback of the video message.

2. The method of claim 1, wherein the step of generating a message reception notification further comprises converting the video message into a video format compatible for playback on a personal computer.

3. The method of claim 2, wherein the step of transmitting the message reception notification to the subscriber further comprises the step of transmitting the formatted video message to an email address associated with the subscriber.

4. The method of claim 3, wherein the step of receiving the message reception notification further comprises receiving the email message.

5. The method of claim 4, wherein the step of initiating the playback of the video message further comprises the step of opening the formatted video message with a media player compatible with the formatted message.

6. The method of claim 1, wherein the step of generating a message reception notification comprises converting the video message in the AVI format.

7. The method of claim 6, wherein the step of transmitting the message reception notification to the subscriber further comprises the step of transmitting the AVI format video message to an email address associated with the subscriber.

8. The method of claim 7, wherein the step of receiving the message reception notification further comprises receiving the email message.

9. The method of claim 8, wherein the step of initiating the playback of the video message further comprises the step of opening the AVI format video message with an AVI compatible player.

10. The method of claim 1, wherein the step of generating a message reception notification comprises creating an SMS notification message that indicates that a video message has been received.

11. The method of claim 1, wherein the step of generating a message reception notification comprises creating an SMS notification message that indicates that a video message has been received and identifies a URL at which to retrieve the video message.

12. The method of claim 1, wherein the step of generating a message reception notification comprises creating an email message that includes a hyper link to the video message.

13. The method of claim 1, wherein the step of generating a message reception notification comprises creating an audio message.

14. The method of claim 13, wherein the step of transmitting the message reception notification to the subscriber comprises depositing the audio message in the subscriber's voice mail box.

15. The method of claim 1, wherein the step of generating a message reception notification comprises generating a video clip.

16. The method of claim 15, wherein the step of transmitting the message reception notification comprises emailing the video clip to the subscriber's video mail account to be delivered as video mail.

17. The method of claim 1, wherein the step of generating a message reception notification comprises creating an audio message and a thumbnail picture associated with the video message.

18. A method for enhancing the delivery of video messages for subscriber, the method comprising the steps of:
receiving a video message directed to the particular subscriber;
converting the video message into a selected video format;
attaching the converted video message onto an email message;
addressing the email message to the particular subscriber;
transmitting the email message to the subscriber over a data network; and
transmitting the video message to a user device over a telecommunications network.

19. The method of claim 18, wherein the selected format is the AVI format.

20. A method for enhancing the delivery of video messages for subscriber, the method comprising the steps of:
receiving a video message directed to the particular subscriber;
converting the video message into a selected video format, selected from the formats of DVD/VCD, AVI, MPEG, WMV, RM, RMVB, DivX, ASF, VOB;
attaching the converted video message onto an email message;
addressing the email message to the particular subscriber; and
transmitting the email message to the subscriber.
